(19) United States
(12) Patent Application Publication
(10) Pub. No.: US 2024/0207911 A1
(43) Pub. Date: Jun. 27, 2024

(54) Systems and Methods for Treatment of Materials

(71) Applicant: J. Bradley Mason, Pasco, WA (US)

(72) Inventor: J. Bradley Mason, Pasco, WA (US)

(21) Appl. No.: 18/288,378

(22) PCT Filed: May 5, 2022
(86) PCT No.: PCT/US22/27938

§ 371 Date: Oct. 25, 2023

Related U.S. Application Data
(60) Provisional application No. 63/185,247, filed on May 6, 2021.

(51) Int. Cl. B09B 3/35; B09B 3/38; B09B 3/40

(52) U.S. Cl. CPC B09B 3/35; B09B 3/38; B09B 3/40

(57) ABSTRACT

Waste treatment systems are provided that can include: an elongated vessel having a length greater that a width, the elongated vessel comprising: an inlet configured to receive waste for treatment; a solids outlet configured to discharge solid treated waste residue; and a gas outlet configured to discharge gas generated during waste treatment; one or more scroll(s) within the vessel and configured to be rotated therein; and a media bed within the vessel and physically engaged with the scroll. Methods for treating waste within an elongated vessel are provided, the methods comprising: providing waste to within an elongated vessel; exposing the waste to media within the elongated vessel to form both a solid treated waste residue and a gas; removing the solid treated waste residue from the elongated vessel via a first discharge conduit; and removing the gas from the elongated vessel via a second discharge conduit.

### CLAIM FOR PRIORITY

This application claims priority to U.S. patent application Ser. No. 63/185,247 filed May 6, 2021, entitled “Apparatuses and Methods for Thermal Treatment of Materials”, the entirety of which is hereby incorporated by reference.

### TECHNICAL FIELD

The present disclosure relates generally to systems and methods for treatment of materials such as solutions, slurries, solids, and/or mixtures of same. Particular embodiments of the disclosure relate to the thermal treatment of waste materials, including, but not limited to industrial and radioactive waste materials and biomass.

### BACKGROUND

There is a wide variety of thermal treatment devices and processes known in the art. Existing thermal treatment devices generally operate upon one or more known input materials that may have a consistent composition. Often, a different system is required to treat each type of input material. The prior art processing devices have limitations and operating restrictions that make treatment of only a limited range of input materials feasible for each processing device.

Example implementations of the present disclosure can treat a much wider range of input materials successfully and efficiently over wider temperature ranges.

### SUMMARY

Waste treatment systems are provided that can include: an elongated vessel having a length greater that a width, the elongated vessel comprising: an inlet configured to receive waste for treatment; a solids outlet configured to discharge solid treated waste residue; and a gas outlet configured to discharge gas generated during waste treatment; one or more scroll(s) within the vessel and configured to be rotated therein; and a media bed within the vessel and physically engaged with the scroll.

Methods for or treating waste within an elongated vessel are provided, the methods comprising: providing waste to within an elongated vessel; exposing the waste to media within the elongated vessel to form both a solid treated waste residue and a gas; removing the solid treated waste residue from the elongated vessel via a first discharge conduit; and removing the gas from the elongated vessel via a second discharge conduit.

### DRAWINGS

Embodiments of the disclosure are described below with reference to the following accompanying drawings.

FIG. 1 depicts a longitudinal cross section of a treatment system in a vertical alignment according to an embodiment of the disclosure.

FIG. 2 depicts a longitudinal cross section of the system of FIG. 1 in an inclined alignment according to an embodiment of the disclosure.

FIG. 3 depicts a longitudinal cross section of a treatment system in the vertical alignment according to an embodiment of the disclosure.

FIG. 4 depicts a longitudinal cross section of a treatment system in the vertical alignment according to an embodiment of the disclosure.

FIG. 5 depicts a longitudinal cross section of a treatment system in the vertical alignment according to an embodiment of the disclosure.

FIG. 6 depicts a longitudinal cross section of a treatment system in the vertical alignment according to an embodiment of the disclosure.

FIG. 7 depicts a longitudinal cross section of the system of FIG. 2 in inclined position with the addition of an external in-line resin slurry dewatering component.

### DESCRIPTION

In accordance with at least one implementation, the present disclosure provides a thermal treatment tubular (elongated) vessel system and method that provides substantial benefits over the prior art using design and equipment elements to provide reliability and flexibility for treatment of a very wide range of input materials over a wide range of operating temperatures without the problems associated with the prior art. The system can be provided as a tubular vessel. The scroll of the system can compliment the walls of the tubular vessel. Other scroll/vessel configurations are contemplated. In accordance with example implementations, the elongated vessel can have a length greater than a width (diameter, in at least one cross section).

At least one implementation of the system can include a tubular heat transfer vessel with an internal rotating spiral shaftless scroll and a media bed internal to the tubular vessel that is slowly agitated by the rotating spiral scroll. The tubular vessel may be arranged in the vertical or inclined (sloped) orientation. At least one aspect provided in the present disclosure is that the rotating helix scroll is arranged and the media sized such that a single layer of media, typically spherical ceramic structures, can prevent metal-to-metal contact between the spiral and the vessel wall such that erosion and wear of both the spiral and vessel wall are reduced and the rotational torque required to rotate the scroll is significantly reduced. In accordance with at least one implementation, the scroll can rotate on top of (sloped applications) or centralized (vertical applications) in a single layer of media structures (balls). In addition, the scroll rotation imparts media movement that can maintain all scroll surfaces; the tubular vessel internal heat transfer surfaces and the media structures alone or in combination can clean or be cleared of deposits, melts, fouling, etc.

A system and processing method is also described that can perform the following processing objectives (operations) with input materials including liquids, slurries, gases, and/or solids; change of phase; change of composition; dewatering of slurries, concentrating; drying; reacting to change composition; agglomerating; crushing or size reduction; mixing; segregation; gasifying; melting of input materials; conversion of input materials into water insoluble mineral compounds with and without co-reactants, and thermal decomposition or pyrolysis of organic and inorganic input materials and co-reactants. One or more of the system and processing methods can process many types of materials that are sized to pass-through the inlet port.

At least one design of the present disclosure provides a vertical or inclined tubular vessel with one or more internal rotating helix spiral scroll(s) that recirculates or agitates a media bed that can facilitate controlled heating or cooling; mixing; contacting, transfer and mixing of input materials with gaseous, liquid and/or solid co-reactants; and separation of the media bed from input and output treated residues such that the media bed stays in the tubular vessel.

At least one embodiment of the present disclosure can overcome at least some of the prior art equipment and processing limitations. In prior art processes input materials that have been thermally treated in two types of thermal treatment methods that utilize media beds. The Type 1 treatment method is represented by the recirculating media bed system in accordance with U.S. Pat. No. 5,470,544 (the entirety of which is incorporated by reference herein). The Type 2 treatment method is represented by the agitated media bed system in accordance with U.S. Pat. No. 4,711,185 and JP 2017142210 (the entirety of each of which is incorporated by reference herein). The present disclosure provides moving bed principles that can have treatment capability for a very wide range of liquids, pastes, sludges, slurries, and solids within a single process chamber unit, the elongated vessel, including introduction of co-reactants to facilitate chemical and physical changes that are not possible with prior art moving bed devices.

In accordance with at least one implementation, the present disclosure overcomes the limitations of the prior art thermal treatment media bed units by incorporating one or more of the following features into a single treatment system and method: 1) utilizes a shaftless rotating helix spiral metal ribbon (scroll) that provides continuous self-cleaning of the scroll itself (possible since the scroll has no shaft that would otherwise accumulate deposits), the tubular vessel heated walls, and the media bed; 2) utilizes a media bed that remains in the tubular vessel and does not require external media recirculation, heating or cleaning systems; 3) utilizes a media bed that can provide catalytic or increased reaction surface area and improved mixing that facilitate more efficient and more complete reactions in the tubular vessel; 4) one or more rotating helix spiral ribbon scrolls agitate the media bed so heat transfer rates and treatment throughput and reaction rates are accelerated as the self-cleaning action of the media bed also maintains the heat transfer surfaces of the tubular vessel walls clear of fouling; 5) the agitation and shearing of the media bed by the rotating spiral ribbon scroll(s) can efficiently handle all types of liquids, slurries, pastes, sludges, solids and even materials that melt at the operating temperature as the scroll metal surfaces are rubbed clean against the media bed with each revolution and the tubular vessel walls are also cleared of any deposits by the agitated media bed; 6) due to the spiral ribbon scroll(s) slow rotation but continuous strong shear and agitation of the media bed and cleaning of the tubular vessel walls it is feasible to treat liquids and solids that melt or turn into pastes as they dry and heat-up, to concentrate liquids and slurries with a more concentrated liquid or thick slurry as an output treated residue, to melt certain materials such as plastics, organic solids, and inorganic solids (like nitrates) to produce a concentrated liquid, slurry or melted product or enhance desired reaction kinetics; 7) depending upon the input materials properties, it is feasible to input materials into the top of the tubular vessel and remove reacted product (treated residues) out the bottom of the tubular vessel and vice versa, where the input materials can be metered into the bottom of the tubular vessel and the reacted product removed from the top of the tubular vessel; 8) co-reactants can be added into the tubular vessel at any position along the length of the tubular vessel as needed so different reactions can occur in one end of the tubular vessel versus the middle or other end of the tubular vessel, wherein the co-reactants and the input materials are well-mixed due to the efficient rotating spiral ribbon scroll(s) agitation of the media bed; 9) any gases produced by the thermal treatment of the input materials and co-reactants can be discharged out the top, bottom or both the top and bottom of the tubular vessel, thereby providing processing flexibility when treating certain materials that produce large amounts of gases; 10) the rotating helix spiral ribbon scroll(s) are operated to not only agitate but recirculate the media bed and mix and transfer the input materials and/or treated residues longitudinally along the axis of the tubular vessel thereby facilitating mass transfer and moving the input materials to regions of the tubular vessel that have increased operating temperatures, i.e. not solely to mix or stir the media bed; 11) optionally, may utilize a second shaftless rotating helix spiral scroll arranged longitudinally in the central axial portion of the tubular vessel and media bed; 12) wherein the second inner rotating helix spiral scroll can further agitate the bed, shear pastes and melted materials to prevent agglomeration formation and ensure more uniform coating of input materials on the surface media bed beads; 13) further, the rotating action of the second inner helix spiral scroll ensures that the input materials and treated residues progress from the input materials inlet location to the treated residues outlet location; 14) alternatively, the rotation direction or twist of the second helix spiral scroll may be opposite to the outer or vessel wall helix spiral scroll to provide positive recirculation of the media bed and contents in a full top-to-bottom-to-top and back movement pattern so the media bed and contents are not stagnant in one region of the tubular vessel; 15) optionally, a media bed transfer channel may be utilized to facilitate gravity-based internal recirculation of the media bed from the most elevated end of the tubular vessel to the lower end or region of the tubular vessel; 16) optionally, insertion of the second helix spiral scroll internal to the media bed transfer channel to further facilitate flow of the media bed either upward or downward within the transfer channel; 17) additionally, wherein the second spiral scroll has its own drive independent of the main scroll drive; 18) optionally, the second helix spiral scroll can be attached to the same terminating drive end as the main scroll so the inner helix spiral scroll rotates at the same speed as the main scroll; 19) the media bed transfer channel can be replaced by an internal heating source to provide additional heat input internally to the media bed; 20) the main scroll drive end may be located at the lower end of the tubular vessel such that rotation of the main scroll pushes the media bed and input materials upward to the upper end that is at a higher elevation, thereby providing the capability to efficiently handle large objects including: trash, rocks, fibrous materials, plastic, rubber, and similar objects and materials that would typically wind or wrap around or foul the scroll if the drive end were at the upper end of the tubular vessel; 21) the exclusive use of shaftless helix spiral scroll(s) to mix, move and agitate the media bed, input materials and treated residues eliminates the most common failure modes of typical shafted screw system that readily become blocked, plugged or fouled or are subject to deposit build-up and binding when contacting materials that melt, are sticky or paste-like as there are no shafts or screw flights used in at least one implementation of the present disclosure to become fouled, plugged or caked; 22) for treating input materials that tend to foam, the media bed above the foam generation surface is kept hot such that the liquid in the foam bubbles will evaporate or decompose thereby breaking (destroying) the foam; 23) a unique aspect of the present disclosure is that the rotating helix spiral scroll is arranged with a unique shape and diameter and the media sized such that a single layer of media, typically spherical ceramic structures, prevents all metal-to-metal contact between the rotating scroll and the vessel wall (without the need for internal shaft bearing supports or wear plates) such that erosion and wear of both the scroll and tubular vessel internal walls are reduced as the scroll rotates on top of (sloped applications) or centralized (vertical applications) in a single layer of slowly rolling media structures (balls), which provides the equivalent of constantly replacing, moving ball bearings under the edges of the scroll between the outer edge of the scroll and the internal tubular vessel wall; 24) importantly, the spiral rotation of the scroll imparts media movement that maintains the tubular vessel internal heat transfer surfaces, all surfaces of the scroll and the media structures clean or clear of deposits, melts, fouling, etc. without the typical metal-to-metal contact of rotary screw type devices where the rotary screw outer edges rest on and wear against the internal vessel wall of the device (this contact is eliminated as discussed in number 23 above); 25) the rotary spiral scroll requires no internal nor external radial bearings as the media balls maintain the scroll accurately aligned radially inside the tubular vessel along its full length (axial thrust forces are generally managed by the drive unit) which greatly simplifies the mechanical design and maintenance for high temperature operations as no scroll internal or external bearings are required instead of two or more bearings and seals of typical rotary screw and mixing devices where the screw or mixer shaft(s) must be supported from both ends (and in the middle as well for some long screw devices) to reduce wear and erosion due to contact of the screw against the vessel wall or the shaft must be of heavy design with at a minimum two or more external load bearings to maintain the shaft aligned inside the treatment unit; and 26) the tubular vessel typically has a 4 to 10 length to diameter ratio that allows different temperatures to be controlled along the length of the tubular vessel to accommodate different chemistry and thermal operations along the length of the tubular vessel that is not possible with prior art moving bed devices.

Implementations of the present disclosure can provide a smaller, simpler thermal treatment system and method with increased processing flexibility and throughput related to input materials that can be efficiently thermally treated. Thereby, a single system can be used to treat a wide variety of input materials. Aspects of the present disclosure can be maintained free from blockages, plugging, deposits, fouling, etc. of the rotating helix spiral scroll(s), media bed structures and the tubular vessel internal walls and heat transfer surfaces. The mixing and shearing action of the rotating (shaftless) helix spiral ribbon scroll(s) together with the tubular vessel being filled or mostly filled with an internally recirculating media bed makes the unit self-cleaning and free of fouling, plugging, caking, and deposits on the rotating helix spiral scrolls, media bed and tubular vessel internal heat transfer surfaces.

Significant unique and novel advantageous features of the present disclosure compared with prior art systems include: 1) no internal or external radial bearings are required as the disclosure utilizes the media balls to maintain the rotating scroll radial alignment in both vertical and sloped embodiments; 2) the tubular vessel arrangement with a 4 to 10 length to diameter ratio greatly enhances heat transfer into the bed as there is more media/vessel wall heat transfer area for a given media bed volume with shorter heat transfer pathways between the heated tubular vessel wall and the input materials and uniquely, the temperature can be controlled at different temperatures along the axial length of the tubular vessel allowing staged evaporation, drying, chemical reactions, melting, mineralization, organic decomposition or other thermal treatment in different zones along the length of the tubular vessel; 3) the capability to slope (incline) the tubular vessel provides means to adjust the residence time of solids inside the tubular vessel without use of mechanical or pneumatic means; 4) the use of a tubular vessel allows an axially arranged heater assembly to be inserted inside the media bed along the internal length on the centerline of the tubular vessel to provide increased heat transfer into the media bed; 5) capability to add an internal channel in the tubular vessel can enhance media recirculation for larger applications; 6) the inclined tubular arrangement allows larger objects to be segregated and removed from the bed out the upper region of the tubular vessel; and 7) there is no central shaft inside the tubular vessel that must be supported by bearings and which is subject to fouling and agglomeration formation.

Embodiments of the present disclosure provide a system and process method for thermal treatment of a wide variety of input or feed materials including: liquids, slurries, pastes, solids, gases and combinations thereof. The present disclosure is particularly functional when treating input materials that exhibit the following characteristics that typically are unacceptable for prior art thermal treatment systems that utilize internal moving media beds due to system plugging, agglomeration, caking, foaming, melt and solids deposition, etc. The following input materials can be readily introduced into and successfully thermally treated in the present disclosure: 1) liquids or slurries that turn into high viscosity pastes, adherent crystals or solidify when dried; 2) liquids, slurries, pastes, and solids that undergo melting at the operating temperature; 3) liquids that produce foam when heated; 4) materials that release large energy exotherms and/or large gas evolutions upon heating; 5) large and fibrous materials (such as trash, paper, plastics, rope, tires, biomass, etc.) that tend to wind around or blind mechanical transfer devices, such as shafted screws or mixer blades.

A unique feature of the present disclosure is that liquid, paste and/or slurry input materials that tend to foam or agglomerate or form hard or sticky deposits during thermal treatment or otherwise tend to foul the moving bed or the inlet port region of the tubular vessel may be injected directly below the top surface of the media bed along the centerline of the scroll. Generally, such input materials readily flow or can be pumped or injected via pressure. This is achieved as the scroll drive/motor and short external shaft can be arranged such that the scroll drive shaft has an internal hollow passage on its centerline through which the input materials can be safely and reliably injected or pumped into the 10-M region of the media bed without contacting any tubular vessel internal surfaces, media bed interfaces or scroll surfaces. In this arrangement the short, hollow drive shaft may comprise a suitably sized pipe through which the input materials can be directly injected or pumped into the center of the 10-M region of the media bed or a secondary pipe may be inserted through the axial length of the hollow drive shaft such that the input materials enter the centerline of the media bed in the 10-M location such that the input materials only contact the heated, well-mixed media bed in the vicinity of the open end of the secondary pipe. The movement of the media bed maintains the external surfaces of the secondary pipe clear of deposits or fouling. With use of a secondary axially arranged pipe a swivel joint is placed on the external end, so the supply of the input materials does not rotate as the scroll and its related short, hollow drive shaft rotate. Co-reactants can also be introduced into the 10-M region of the bed using this same approach.

As a further embodiment of the present disclosure the input materials and/or co-reactants may be introduced into the media bed to the 10-M position on the centerline of the media bed near the bottom of the media bed by means of an internally located pipe, inserted into the tubular vessel on the vessel centerline but from the non-drive end of the tubular vessel.

The input materials that are suitable for thermal treatment in the present disclosure include, but are not limited to liquids, solutions, slurries, pastes and solids including the following: waste with organic compounds, alkali metal compounds, sulfur-containing compounds, halogen-containing compounds, compounds that melt, radioactive waste, biomass, solid waste, ion exchange resins, chlorinated or fluorinated organic solvents, low-boiling point organics, oils, solvents, organic acids, organic bases, decontamination solutions, high-boiling point organics, plastics of all kinds, paper, rubber, tires, oils, greases, wood, cellulose, cardboard, tar, bitumen, wax, cloth, tetraphenyl borate compounds, nitrates, nitrites, phosphates, nitric acid, hydroxides, co-reactants, etc.

Additionally, the inorganic constituents of the input materials include, but are not limited to; metals and metal oxides including: Fe, Cr, Ni, Mn, Mo, and Zn; mineral acids including nitric acid, sulfuric acid, etc.; hydroxides including sodium and potassium hydroxide, etc.; nitrates and nitrites including sodium and potassium nitrate and nitrite; tri-sodium phosphate, tetraphenylborates, alkaline earth compounds including Mg, Ca, Sr, and Ba; and compounds that have one or more of the following elements: H, Li, B, C, N, O, F, Na, Al, Si, P, S, Cl, K, Ca, Ti, V, Co, Cu, As, Se, Br, Zr, Tc, Ru, Rh, Ag, Cd, Sn, Sb, I, Cs, Ba, Re, Pt, Hg, and Pb.

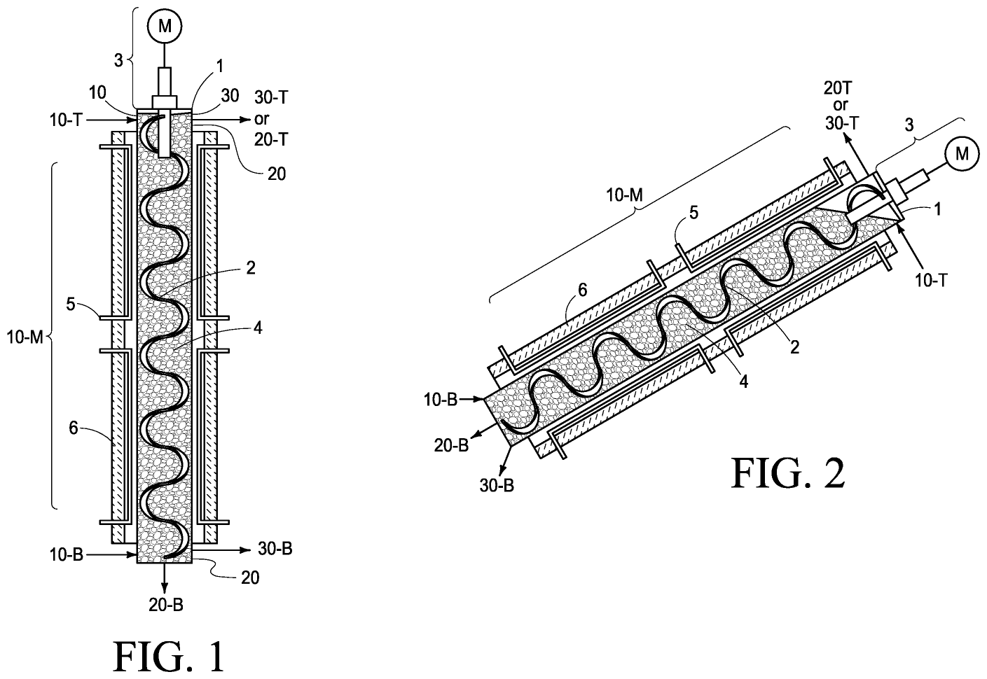

The present disclosure provides a unique system and process method that can resolve all the above-mentioned thermal treatment challenges. Additional details of these systems and methods are provided with reference to FIGS. 1-7.

Referring first to FIG. 1, an example embodiment of a treatment system is provided illustrating the heated tubular vessel, internal rotating helix spiral scroll and media bed. Input material (solids, liquids and/or gases) are shown optionally entering the vessel near the upper section of the system, along the length of the vessel, and/or near the bottom of the vessel. Evolved or outlet gases are generally discharged from the top or bottom of the system. Treated residues may be discharged from the bottom or top of the system.

Depicted in FIG. 1, is an example longitudinal cross section of the system in the vertical position illustrating the heated tubular vessel 1; internal rotating helix spiral ribbon scroll 2 with drive motor, gearbox assembly and seal 3; recirculating media bed 4; external heat supply or sources (heaters) 5; insulation housing 6 surrounding heaters 5 and tubular vessel 1; with input materials 10 entering near the upper section of the system 10-T, or along the length of the tubular vessel 10-M or entering near the bottom section of the system 10-B; output gases 30 being discharged from the top of the system 30-T or from the bottom of the system 30-B and treated residues 20 being discharged from the bottom section of the system 20-B or from the upper section of the system 20-T.

The tubular vessel 1 can include a length of alloy pipe or plate, cylindrically rolled and welded or similar design where the length of the tubular vessel 1 is three or more times the tubular vessel 1 diameter. The tubular vessel 1 length can be 3 to 20 times the vessel 1 diameter so the thermal treatment can be more easily controlled as the temperature and even the composition of the input materials and resultant treated residues can be adjusted and controlled along the length of the tubular vessel 1. Additional embodiments can utilize tubular vessel lengths between 4 to 10 times the vessel diameter. For example, in FIG. 1 the input materials 10-T, 10-M and 10-B represent locations along the length of the tubular vessel 1 where input materials 10 can be pumped, metered or otherwise injected into the tubular vessel 1 in any location between the top of the tubular vessel 1 and the bottom of the tubular vessel 1 as required to achieve processing objectives.

Examples are provided in this section of variations of input materials 10 location that facilitate thermal treatment of a wide range of input materials 10. Additional media can be added to media bed 4 of the tubular vessel 1 that would preferentially be input near the top of the tubular vessel 1, just above the top of the recirculating media bed 4 level. Additional input materials 10, such as gas, solid or liquid co-reactants may be added through single or multiple nozzles as required by processing requirements.

A further description of the input materials 10 makeup is provided below in this section.

During treatment operations the internal rotating helix spiral ribbon scroll 2 is slowly rotated (generally 1 to 5 revolutions per minute [RPM]) by the motor and gearbox assembly 3 either continuously or intermittently to strongly but slowly agitate and move the media bed 4 along the length of the tubular vessel 1. The spiral ribbon scroll 2 is constructed of metal suitable for the potential corrosive, erosive and thermal conditions inside the tubular vessel 1. Suitable alloys for the spiral ribbon scroll 2 and tubular vessel 1 walls in this type of service have been shown to be iron and/or nickel-based alloys with high chromium and nickel content with additional minor alloying elements such as molybdenum, cobalt, tungsten, silicon, niobium, aluminum, and others.

The spiral ribbon scroll 2 is constructed so the outer diameter (outer edge) of the spiral ribbon scroll 2 does not contact the inside diameter of the tubular vessel 1 walls. The size and shape of the media bed 4 structures (typically substantially spherical ceramic balls) is selected such that the media 4 forms a novel one-layer thick rotating bearing of ceramic media balls 4 under the outer edge of the scroll 2 such that the scroll 2 does not contact the internal metal surfaces of the tubular vessel 1. This occurs in both the vertical and sloped applications of the present disclosure.

The rotating scroll 2 can impart movement to the media bed 4 both inside the scroll 2 and in the one-layer thick media 4 spheres between the outer edge of the scroll 2 and the internal surface of the tubular vessel 1. The slow rotating movement of the one-layer thick spherical media 4 maintains the internal surfaces of the tubular vessel 1 free of any deposits, fouling, caking, melts, etc. The outer edge of the scroll 2 rides on the one-layer thick rotating spherical media 4 such that there is no metal-to-metal contact between the scroll 2 and the internal surfaces of the tubular vessel 1. This dramatically reduces the rotational energy required to rotate the scroll as the weight and forces on the scroll rest upon the slowly rotating spherical media 4 such that friction, wear and erosion may be reduced for both the scroll 2 and the tubular vessel 1. This is at least one feature of the present disclosure. This feature is functional in both vertical and sloped applications of the disclosure. This unique and novel feature eliminates the need for internal and/or external radial shaft support bearings otherwise required in all prior art systems that utilize an internal mixing device.

All surfaces of the rotating scroll 2, the media bed 4 structures and the internal surfaces of the tubular vessel 1 can thereby continuously be maintained clear of deposits, fouling, agglomerates, caking, etc. via the self-cleaning action of the slowly rotating media bed 4 structures. The self-cleaning operation of the scroll 2 and the media bed 4 can not only reduce wear and erosion of metal surfaces but also maintains high heat transfer rates as deposits, caking or fouling on the tubular vessel 1 walls could otherwise dramatically reduce heat transfer into the media bed 4. Heat transfer is also improved as the rotating scroll 2 also moves the media bed 4, input materials 10 and treated residues 30 that are closest to the heated tubular vessel 1 walls back into the bulk of the media bed 4 thereby increasing the thermal gradient and improving heat transfer from the tubular vessel 1 walls to the media bed 4, input materials 10 and treated residues 20, which improves overall system throughput compared with the prior art.

The scroll 2 may be fabricated of the same metal alloy as described above for the tubular vessel 1 walls. However, it may be advisable in treating certain highly abrasive input materials 10 that the scroll 2 be constructed of an abrasion resistant alloy as it slowly rotates continuously and may be subject to higher erosive wear than the tubular vessel 1 walls.

The motor and gearbox drive assembly 3 may be of any commercial design that is suitable for the speed and torque required to rotate the spiral 2 through the media bed 4, input materials 10 and treated residues 20 that will be in the media bed 4 that require higher torque to maintain the media bed 4 circulation pattern, such as: pastes, melts, sticky solids, deposits, agglomerations, etc. The motor and gearbox drive 3 can have variable speed capability. The required rotation speed must be determined for each application, i.e. for each set of input materials 10. Typically, the rotational speed of the motor and gearbox drive assembly 3 can vary between 0.2 and 10 revolutions per minute (RPM), or between 1 and 5 RPM.

Gases 30 that are evolved from the thermal treatment process frequently include; steam; volatile organic carbons (VOCs); acid gases (HCl, SOx, NOx, etc.); carbon monoxide; carbon dioxide; nitrogen and other minor gases. The produced gases 30 generally are discharged from either the top of the tubular vessel 30-T or the bottom of the tubular vessel 30-B, depending upon the selected processing objectives with examples provided below in this section.

The media bed 4 utilized in the system may be of widely variable composition depending upon the processing objectives and treatment requirements for the input materials 10. In some implementations, the media bed 4 can include granular to rock-sized solid materials that can be efficiently transported, moved, mixed and blended by the rotating scroll 2 while being sufficiently large to be readily separable from the treated residues 20, but no larger than 12 percent (⅛th) the inside diameter of the tubular vessel 1 to prevent media bed bridging. For efficient separation of the media bed 4 from the treated residues 20, to maintain high heat transfer rates within the tubular vessel 1, and to minimize agglomeration or stickiness potential of the input materials 10 with the media bed 4; the media bed 4 bead/ball size should be no less than 0.25 inch (6.3 mm) but no more than 12 percent of the inside diameter of the tubular vessel 1. The size of the media 4 beads typically can be between 0.39 inch (10 mm) and 2.0 inch (50 mm).

The media 4 beads may be of any geometric shape that is non-interlocking, although free-flowing is not a requirement. The shape of the media 4 beads can be solid objects that are substantially spherical in shape, with smooth surfaces and minimal corners that can be abraded to thereby minimize or essentially eliminate generation of fine-sized particulate that will combine with the treated residues 20 and to serve as the internal 1-layer thick media ball layer that constantly maintains the scroll radial alignment inside the tubular vessel 1 without need for internal or external bearings. The drive/motor 3 provides axial alignment, thereby eliminating use of any radial bearings inside or external to the tubular vessel 1. This a unique and novel feature of the present disclosure that is not in any prior art device that utilizes a rotating shaft or mixer capability.

The media bed 4 beads or balls can have composition that matches the processing requirements for the input materials 10 to be treated. The media bed 4 may be: reactive so the media bed 4 actively participates in reactions with the input materials 10, treated residues 20, and/or gases 30 inside the tubular vessel 1; catalytic so as to facilitate chemical reactions or improve kinetics of the reactions between the input materials including co-reactants 10, treated residues 20, and/or gases 30 inside the tubular vessel 1; or inert or mostly inert to prevent or minimize chemical or physical interaction between the media bed 4 and other constituents inside the tubular vessel 1. The media 4 beads may have a composition of one or more of most of the elements in the periodic table that can be formed into the suitably sized media bed 4 beads/balls including essentially all of the elements in the periodic table except the actinides, halogens and Nobel gases.

Of special importance for use as constituents in the media bed 4 beads are the following major constituents: alkaline earth elements (in particular: Ca and Mg), transition metals (in particular: Fe, Ni, Cr, Co, Mo, Nb, Mn, Ti, Zr) and catalytic species (such as Va, Rh, Pd and Pt); oxides of the poor metals (in particular: Al and Sn); metalloids (in particular: B and Si), non-metals (in particular: C); and the following as minor or trace constituents: alkali metals and non-metals, Zn, phosphates, nepheline, feldspathoids, zeolytes, aluminum hydroxide, nitrides, silicates, clays and carbides. In most applications the media 4 beads will consist of mixtures of ceramic oxides, metals and/or metal oxides, such as: alumina, silica, zirconia, magnesium silicate, cerium oxide compounds, ceramic matrices, glasses, metals, metal spinels, metal oxide composites, clays, and mixtures thereof. The media 4 beads can be hard, fracture and impact resistant, abrasion resistant, thermal shock resistant, resistant to alkali metal attack and halogen and salt-based corrosion, such as fused or sintered high-alumina or high-zirconia content grinding media and the media 4 may be porous or non-porous. Additionally, the media bed 4 may be comprised of more than one size and composition. For example, the media 4 beads could be high-alumina spheres with a second media bead made of metal or metal oxide beads or alkaline earth media beads that could have a catalytic effect.

The tubular vessel 1 can be heated externally by heater 5 (heat source). Heater 5 should be arranged around the complete circumference of the tubular vessel 1 and along its length. The heater 5 may comprise a range of commercially available externally and/or internally arranged components including: steam coils or jacket, hot-oil or heat transfer fluid coils or jacket, electrical resistance heater elements, induction heating coils, hot gas recirculation, direct or indirect combustion-fired heater chambers or tubes, internal heat from oxidation or reaction of input materials with co-reactants and other means known in the art that can be arranged around the exterior of the tubular vessel 1 or inserted internally inside the tubular vessel 1 along the internal axial length. For most applications, the heat source 5 is divided into several zones or heating regions along the length of the tubular vessel 1 that can be individually controlled to produce the required processing temperature gradients along the length of the tubular vessel 1. The heater 5 arrangement can include a minimum of two heat zones or regions up to a normal economically practical, but not maximum, limit of 20 zones or regions that each can be individually controlled to provide multiple heated regions inside the tubular vessel 1 and media bed 4 along the length of the tubular vessel 1 as required to facilitate enhanced evaporation, drying, exothermic and endothermic heat of reaction control, thermal degradation or decomposition of organic and inorganic constituents of the input materials, thermal curing of reacted materials, gasification of carbon, etc. For large throughput applications, such as treatment of biomass and solid waste (trash), the tubular vessel 1 can be of such a size that heat source 5 could be an indirectly or direct combustion fired burner or recirculating hot gas heat source or supply. Additionally, for larger tubular vessels 1 additional heat input can be provided by insertion of a long heater through the centerline of the media bed 4 along the axial length of the tubular vessel 1, through the center of the media bed 4 as shown in FIG. 5.

An insulated housing 6 can surround the heater 5 and the tubular vessel 1 as required to retain the heater energy and reduce heat losses.

Referring now to FIG. 2, a depiction of a longitudinal cross section of the FIG. 1 system in the inclined position is provided in accordance with an embodiment of the disclosure of the system. Accordingly, the system is rotated to an inclined angle, which can contribute to needed input material 10 and treated residue 20 flows and flow patterns throughout the tubular vessel 1 and media bed 4. This is particularly important for embodiments that require substantially increased solids residence time of the input materials 10 and/or the treated residues 20. The system may be inclined from vertical to near horizontal (generally greater than or equal to 20 degrees above horizontal) for the planned treatment process requirements. The other components of the FIG. 2 configuration are the same as described for FIG. 1. The capability to incline the tubular vessel 1 is a novel and unique feature of the disclosure, which provides the following significant advantage over vertically or horizontally arranged prior art: the residence time of the input material 10 and treated residues 20 can be significantly increased and controlled as in the inclined position the media bed 4 can contain over 50 volume percent treated residues 20 without increasing the rotational torque of the scroll 2 and drive/motor 3 or causing seizure or blockage of the media bed 4. Testing has shown that use of a rotating mixing device with a closed or restricted treated residues 20 outlet, as in the Type 2 systems, results in rapid seizure of the media bed 4 wherein the rotational torque of the shafted mixing device significantly increases and shaft rotation is stopped or seized due to the high internal friction between the vertically oriented media bed 4 and treated residues 20 particles, if the treated residues are allowed to accumulate inside the media bed. It is obvious from an examination of the design features of all prior art Type 2 vertical systems that no means is ever provided to restrict or stop input materials 10 or treated residues 20 from being freely discharged from the bottom of the media bed 4 for this very reason. This failure mode of all prior art Type 2 systems is completely eliminated by the novel feature of inclining the tubular vessel 1 which prevents media bed 4 and scroll 2 and drive/motor 3 seizure. A valve or similar restriction device can be placed on the treated residue 20 outlet on the tubular vessel 1 or the inclination angle of the tubular vessel 1 can be such that the input material 10 and/or treated residue 20 residence time in the media bed 4 can be increased to hours instead of seconds as occurs with prior art vertically oriented vessels with no bottom restriction or closure on the treated residue outlet.

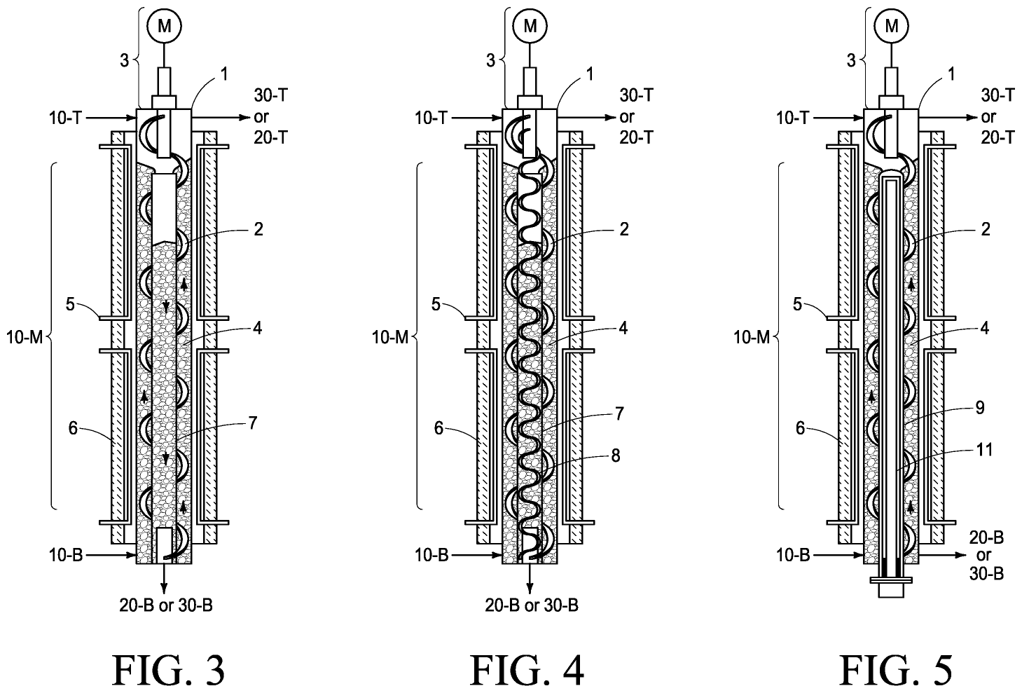

Referring now to FIG. 3, the system of the present disclosure is shown in the same configuration and position as FIG. 1 accordingly depicting a longitudinal cross section of the system in the vertical position illustrating the heated tubular vessel 1, internal rotating helix spiral scroll 2, and media bed 4. A bed media transfer channel 7 is shown installed longitudinally in the central portion of the vessel, which provides a flow path that allows the media bed to flow by gravity from the upper region of the vessel to the lower region of the vessel. The input materials are shown optionally entering the vessel near the upper section of the system 10-T, along the length of the vessel 10-M, and/or near the bottom of the vessel 10-B. Evolved or outlet gases are generally discharged from the top 30-T or bottom 30-B of the system and treated residues may be discharged from the bottom 20-B or top 20-T of the system. The rotating helix spiral scroll 2 and movement of the media bed 4 maintains the tubular vessel 1 internal wall heat transfer surfaces and the external surface of the transfer channel 7 clean and free of deposits and agglomerations.

FIG. 3 illustrates the addition of a media transfer channel 7 that facilitates the enhanced and free recirculation of media bed 4 beads from the upper region of the tubular vessel 1 to a lower region of the tubular vessel 1. In this embodiment the media bed 4 beads move by gravity through the transfer channel 7. The transfer channel is generally constructed of metal alloy similar to the tubular vessel 1 and is centralized inside the main rotating scroll 2 such that the external surface of the transfer channel 7 is maintained clean of deposits or agglomerations by the rotating main scroll spiral 2 and movement of the media bed 4.

Referring now to FIG. 4, a longitudinal cross section of the system of FIG. 3 is shown in vertical position with the addition of a second rotating helix spiral scroll, which in this figure is located inside the bed media transfer channel, wherein the second rotating helix spiral scroll assists bed media to flow from the top of the vessel to the bottom of the vessel. The second rotating scroll also provides shear and agitation of the bed media inside the transfer channel. The second rotating scroll thereby maintains the second rotating scroll and the internal surface of the transfer channel free of deposits and agglomerations. In this figure the second scroll is attached to and shares the drive for the main or primary scroll in vertical position with the addition of a second rotating helix spiral scroll 8, which in this figure is located inside the bed media transfer channel 7, wherein the second rotating helix spiral scroll 8 assists bed media to flow from the top of the vessel to the bottom of the vessel. The second rotating scroll 8 also provides shear and agitation of the bed media 4 inside the transfer channel 7. The second rotating scroll 8 thereby maintains the second rotating scroll 8 and the internal surface of the transfer channel 7 free of deposits and agglomerations. In this figure the second scroll 8 is attached to and shares the drive/motor 3 for the main or primary scroll.

FIG. 4 illustrates the addition of the second rotating helix spiral scroll 8 that is shown located inside the centralized transfer channel 7. The second rotating scroll 8 is shown attached to the drive end of the main rotating scroll 2 such that the single drive and gearbox 3 will rotate both the main and the second scrolls at the same speed. In this configuration, the second scroll 8 would generally be arranged to lift and mix the media bed 4 beads inside the transfer channel 7 to maintain the internal surfaces of the transfer channel 7 cleared from deposits and agglomerations and to enhance the flow of the media bed 4 beads to the lower region of the tubular vessel 1. The second rotating scroll 8 is constructed of the same metal alloy as the main rotating scroll 2.

In an alternative embodiment of FIG. 4, the transfer channel 7 may be removed and the second rotating helix spiral scroll 8 remain centralized in the tubular vessel 1 in which case the second rotating scroll 8 may be arranged to lift the media bed upward within its influence or alternatively, the second rotating scroll 8 may have a reverse spiral that pushes the media bed 4 beads downward or simply provides enhanced mixing in the central regions of the tubular vessel 1. In addition, the second rotating scroll 8 may have an independent motor and gear drive so its rotation direction and speed can be independently controlled to enhance processing needs of certain input materials.

In FIG. 5, as another processing option, the FIG. 1 system is shown in vertical position with the addition of an internal centralized generally tubular heating assembly, the centralized tubular heating assembly providing additional energy input to the media bed that increases the treatment capacity of a given external size tubular vessel. The rotating scroll maintains the external surfaces of the centralized heating assembly clear of deposits, etc. such that the heat transfer rate is maintained near theoretical values. The transfer channel 7 may be removed and be replaced with an internal pipe or sleeve 9 with an integral heater 11 to input energy into the central portion of the media bed 4 along the length of the tubular vessel 1. This feature enhances heat input into the media bed 4 by thus increasing the heated surface area of the tubular vessel 1. Alternatively, the tubular vessel 1 may be heated entirely by means of the internal pipe or sleeve 9 with integral heater 11 with no external heaters 5.

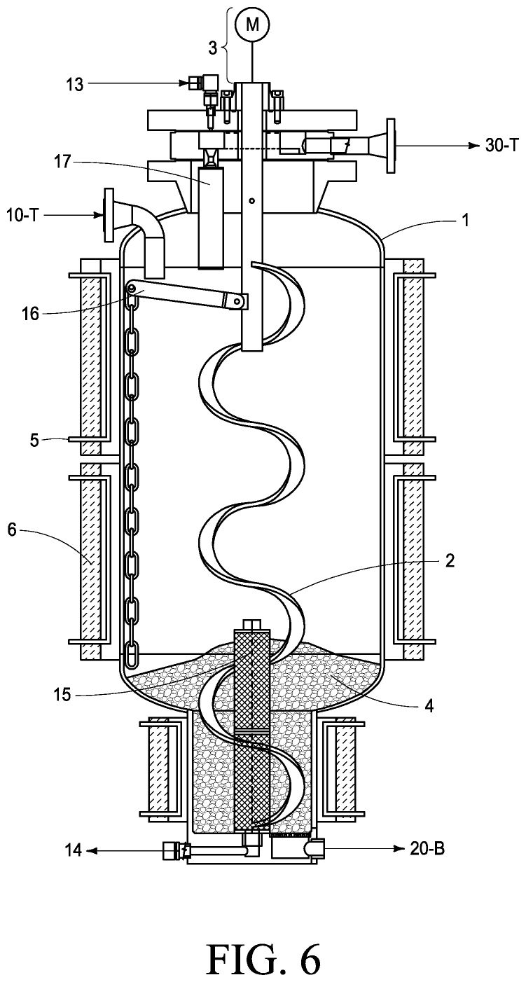

In FIG. 6 is depicted a longitudinal cross section of the FIG. 1 system in vertical position with the enlargement of the tubular vessel 1 along the upper length of the tubular vessel 1 which provides increased internal capacity for holding incoming input materials.

The FIG. 1 system in vertical position with the enlargement of the vessel toward the top of the vessel increases the batch treatment capacity of the system specifically for slurried input materials, such as water slurried ion exchange resin wastes. In addition, a means to dewater the incoming resin/water slurry is provided internal to the tubular vessel and a gas phase filter is optionally added internal to the tubular vessel to ensure that no fine particulate from the waste treatment passes to the downstream process system. Means are provided to remotely clear any accumulated deposits from the dewatering and gas phase filter media. The rotating scroll maintains the internal surfaces of the lower vessel and an optional deposit removal means is provided to maintain the upper vessel shell clear of deposits such that the heat transfer rate is maintained near theoretical values through the vessel wall to the waste stream and the media bed. This embodiment is preferred for batch thermal treatment of organic materials. The increased volume of the tubular vessel 1 is particularly suited for the batch treatment of input materials as the tubular vessel 1 can be filled with an increased volume of input materials. The FIG. 6 embodiment is particularly suited for batch treatment of slurried solid wastes, such as for thermal treatment of ion exchange resin wastes that are transferred in the nuclear power industry using water as the slurry carrier for the ion exchange resin beads. The resin and water slurry waste materials are transferred into the tubular vessel 1 through the 10-T port near the top of the tubular vessel 1. The resin and water slurry fills the enlarged volume of the tubular vessel 1. After the desired quantity of resin and water slurry is transferred into the tubular vessel 1, the inlet port 10-T is closed. Water or similar fluid is then removed by pressurizing the tubular vessel by introducing a gas through the filter pulse clean nozzles 13. The air pressure pushes the fluid, in the case of resin slurry the fluid is water, through the bottom dewatering device filters 15, which is transferred from the tubular vessel 1 through the fluid removal port 14. The resultant dewatered resins or other solid materials are then gradually heated by energizing the heaters 5 to evaporate remaining fluid, usually water, and then heat the input material solids to the set thermal treatment temperatures. The evaporated gases pass through the gas-phase filters 17 (if optionally installed) and are discharged from the tubular vessel 1 through gas outlet 30-T. The media bed 4 in this embodiment is located primarily in the bottom portion of the tubular vessel 1 where residual treated solids accumulate and are size reduced, if necessary, by the agitated media bed 4. The partial length scroll 2 slowly rotates to agitate the media bed 4. Since the scroll only effectively can clean the lower portion of the tubular vessel 1 where the media bed 4 is located, an optional secondary scraper 16 may be provided to maintain the upper portion of the tubular vessel 1 walls clear of deposits, fouling, etc. The optional secondary scraper 16 is connected to the common scroll drive shaft such that both the optional secondary scraper 16 and the scroll 2 are slowly rotated at the same speed by the drive/motor 3. The secondary scrapper 16 is optional as the scroll 2 can be arranged to provide the required deposit removal to maintain the upper portions of the tubular vessel 1 clear of deposits, fouling, etc. The optional secondary scrapper 16 comprises one or more metal alloy attachment arm(s) connected to the scroll drive shaft with a metal alloy chain or similar means provided at the end of the arm that lightly contacts the upper tubular vessel 1 walls thereby efficiently clearing deposits or fouling on the upper tubular vessel 1 walls with minimal erosive action. The scraper chain is self-cleaning as the links move relative to adjoining links. By this means both the upper tubular vessel 1 shell and the lower tubular vessel 1 shell are both maintained clear of deposits such that the heat transfer rate is maintained near theoretical values through the vessel wall to the input materials 10 and the media bed 4. Upon completion of the thermal treatment the residual solids are then transferred from the tubular vessel 1 by opening the solids outlet port 20-B located near or at the bottom of the tubular vessel 1. The optional gas phase filters 17 are periodically pulsed-clean of any accumulated small-sized treated residue particles by introducing pressurized gas, generally nitrogen or air, through the pulse-clean nozzles 13 that thereby clears accumulated fine solids from the surface of the optional gas phase filters 17.

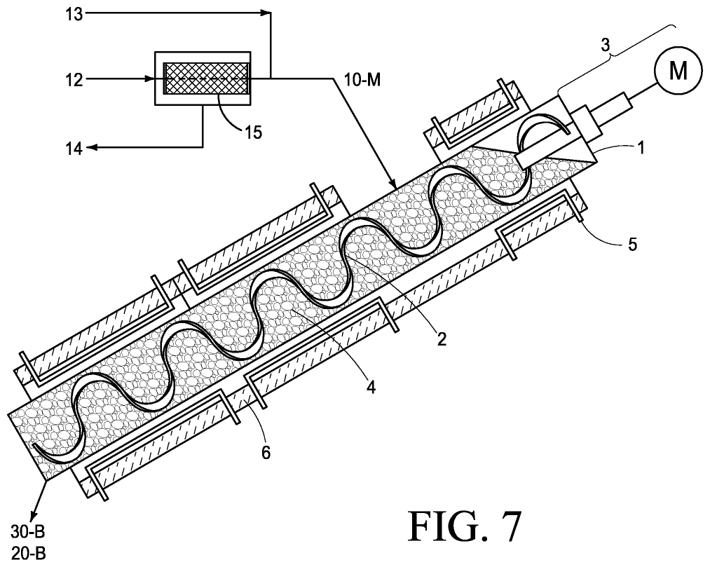

FIG. 7 depicts a longitudinal cross section of the FIG. 2 system in inclined position with the addition of an integral in-line slurry dewater filter 15 located integral to the input materials inlet 10-T, on the waste inlet to the vessel, mounted integrally with the tubular vessel, which greatly increases the continuous treatment capacity of the system specifically for slurried input materials, such as water slurried ion exchange resin wastes. The rotating scroll maintains the internal surfaces of the vessel shell clear of deposits such that the heat transfer rate is maintained near theoretical values through the vessel wall to the waste materials. The removal of the slurry water or excess fluid prior to introduction of the input materials 10 into the tubular vessel 1 greatly reduces the heat requirement for thermally treating the input materials. The slurried input material solids 12 can be continuously dewatered such that only dewatered input material solid particles (input materials 10) enter the tubular vessel 1 through the waste inlet port 10-M. The input material slurry 12 is continuously dewatered as the outer portion of the dewatering filter 15 is maintained at a lower pressure than the incoming input material slurry 12. The water or other fluid is thereby efficiently dewatered or separated from the wetted input material particles on a continuous basis. Residual interstitial water on the dewatered waste particles is further removed by introducing a gas stripping stream 13 simultaneously and continuously into the waste slurry line near or at the outlet of the dewatering filter 15. The introduction of stripping gas 13, generally air or nitrogen, strips any residual water between the input material solid particles so that the dewatered slurry that enters the tubular vessel 1 through the waste inlet port 10-M has much lower water or fluid content than possible with simple water removal through the dewatering filter 15 media. Performing the dewatering step integral to the input material inlet port 10-M greatly reduces the heat load that would be necessary to otherwise evaporate larger quantities of fluid, generally water, that would enter the tubular vessel 1 and eliminates the need for a separate handling or feeder system for the dewatered input materials. This arrangement greatly increases the continuous treatment capacity of the system specifically for granular input materials that are transferred in slurry form, such as ion exchange resin wastes that are slurried with excess water. The rotating scroll 2 maintains the internal surfaces of the tubular vessel 1 walls clear of deposits such that the heat transfer rate is maintained near theoretical values through the tubular vessel 1 walls to the input materials 10, media bed 4 and treated residues 20. Other components of the system are the same as described for FIG. 2. The dewatering filter 15 is required to be located integral to the tubular vessel 1 as it is generally not technically feasible to transfer highly radioactive dewatered solids over a distance. Thus, the dewatering filter 15 and operation of the dewatering filter 15 is an integral part of the tubular vessel 1 system. In this embodiment, the process gases 30 and the treated residual solids 20 are preferably discharged from the tubular vessel 1 at or near the bottom of the tubular vessel 1 in the 20-B and 30-B locations.

In accordance with example implementations of the present disclosure, robust operation and the capability to process larger sized input materials 10 than is possible in prior art moving bed system are provided. In accordance with an embodiment for treating larger input materials 10, the tubular vessel 1 is arranged in a sloped orientation, similar to FIG. 2, but with the rotating helix spiral scroll(s) 2 and optionally 8 extend upward into the media bed 4 from the bottom of the tubular vessel 1 with the motor and gear drive 3 located on the bottom end of the tubular vessel 1. The input materials 10 would be added to the middle 10-M or 10-T locations along the length or into the top region of the tubular vessel 1 and the rotation of the scroll(s) 2 and optionally 8 will mix the large input materials 10 with the media 4 bed providing enhanced heat transfer and more rapid thermal treatment of larger objects than any comparable thermal treatment device. Optionally, the rotating scroll(s) 2 and optional 8 may be configured with teeth or tabs on the inner and/or outer edges or surfaces to facilitate size reduction of larger input materials 10.

A significant advantage of this arrangement is that larger input materials 10, such as: wood, rubber, fibrous or stringy materials, plastics, etc. will not become tangled around the open-ended helix spiral scroll(s) 2 and optionally 8 because as the helix spiral scroll(s) 2 and 8 rotate, materials that may wrap around the spiral ribbon scroll(s) will be moved toward and ejected off the non-driven end of the scroll(s) 2 and 8 as the spirals on the non-driven end are open (no shaft or connection). In this arrangement, the second helix spiral scroll 8 is not normally required but may be included if there are substantial amounts of input materials that melt, such as plastics. For treating large input materials 10 it may be necessary to size reduce or shred larger items such as rubber tires, wood beams, bulk plastics so they can be efficiently added into the tubular vessel 1. Generally, when thermally treating large input materials 10, small-sized treated residue solids (ash) are intermittently removed from the bottom of the tubular vessel 10-B and large non-organic input materials 10 such as rocks, metal objects, etc. are moved by the scroll(s) 2 and optionally 8 to the top end of the tubular vessel 1 position 10-T, where an airlock can be provided for removal of large objects that cannot be thermally decomposed. Of special importance when treating input materials 10 that produce an ash-like treated residue 20 product that the residues be allowed to remain in the tubular vessel for a period of time, up to several hours, to facilitate full gasification of organics to produce treated residues 20 (ash-like with inert carbon char but with substantially no organic content). To accomplish the retention of the ash-like residues for gasification of the carbon, a closure device is provided on the treated residue solids outlet 20-B to provide means to accumulate the ash-like residues in the media bed 4. A gasification agent can then be added, generally at the 10-B and/or 10-M positions, to gasify the residual carbon char in the ash-like residues to produce the final treated residues that contain only inorganic residues with minimal to no carbon char content that are then periodically removed from the tubular vessel 1 by opening the solids outlet closure device located at position 20-B.

Many if not most concentrated solutions become thick pastes as the liquid content is decreased to less than 40 weight percent liquid. The resultant heavy, high-viscosity, adherent pastes readily plug the rotating elements of prior art moving bed devices as the pastes stick to the shaft of the rotating element and the media bed. For such prior art moving bed devices, the paste stage must be avoided to prevent processing failure. Commercial paste drying systems have been developed that include one or more of the following features to prevent unwanted agglomeration on the process equipment: 1) use double (dual) shaft screws where the flights are designed to partially overlap so the rotation of one screw and shaft tend to clear most of the paste-like or sticky solids away from the opposing screw and shaft; 2) use high speed rotating shafts with paddles to break up pastes; and/or 3) use one main rotating shaft with blender screw flights and several independent high speed shear blades to break up and spread out the pastes. There is no need for such specialized paste drying equipment features for the disclosure process as the rotating scroll 2 has no shaft in the media bed 4 and the thin scroll surfaces and internal tubular vessel 1 walls are continuously and effectively self-cleaned from deposits and agglomerations by the shearing action of the agitated media bed 4. This is a unique feature of the disclosure. All prior art devices that include a media bed cannot handle the presence of paste-like input materials or intermediates as the rotating mixing device has two design problems that lead to a certain build-up of agglomerates on the rotating device and inside the media bed: 1) the mixing devices of all prior art devices with a media bed have shafts that cannot be cleaned by the media bed agitation as the shaft surface rotates so slowly due to the small shaft diameter and presence of support arms that connect to the mixing blades that paste-like or wet input materials build-up on the shafts and connecting arms forming hard deposits or agglomerations that cause media bed agglomerates to form, thereby leading to process failure; and 2) the mixing device comprises one or more flat screw flights that contact or are in close tolerance with the heated vessel wall in particular so that the rotation of the mixing blades scrapes deposits off the vessel wall, which prevents contact of the outer edge of the mixing blade with the agitated media bed such that the outer edge of the mixing blades become fouled and are not subject to sufficient shear forces to maintain the mixing blade clear of agglomerate formation, which results in eventual process failure, specifically, binding of the shaft due to high torque caused by fouling between the rotating mixer blades and the hot vessel wall. This is a unique aspect of the present disclosure where the rotating scroll 2 has no shaft internal to the media bed 4 and the outer edge of the scroll 2 is continuously shearing against the single-layer media bed 4 located between the outer edge of the scroll 2 and the inside surface of the tubular vessel 1, which maintains all surfaces of the shaftless rotating scroll 2 clean and clear of potential agglomerating deposits. The action of the rotating scroll 2 on the single-layer of media balls also simultaneously maintains the internal walls of the tubular vessel 1 clean and cleared of potential deposits. The shear forces provided by the single-layer of media balls contacting the internal surfaces of the tubular vessel 1 is what maintains the internal walls of the tubular vessel 1 and all surfaces of the rotating scroll 2 clean and clear of deposits in the present disclosure, not the high friction and high torque scraping action of the metal mixing device contacting the internal metal surfaces of the vessel as in all prior art processes. The use of a shaftless scroll that rotates on the single-layer of media balls provides efficient cleaning and clearing of deposits on all internal tubular vessel 1 surfaces and on the scroll 2 as well, whereby the present disclosure can treat input materials 10 that melt, that form heavy pastes, etc. that would cause process failure of all prior art devices that have media beds.

The present disclosure provides a reliable and efficient method to handle melted or thick, adherent pastes and sticky input materials 10 by use of the recirculation of hot media bed 4 beads and the arrangement of the shaftless rotating helix spiral scroll(s) 2 and optionally 8. The action of the shaftless scroll(s) 2 and 8 and the sheared media bed 4 serve to shear such heavy pastes into smaller globs or pieces that are dried as the media bed 4 transfers the small isolated sticky pieces of concentrated pastes into hotter regions of the tubular vessel 1 while simultaneously clearing any adherent or melted input materials from all surfaces of the rotating scroll(s) 2 and optionally 8 and the internal surfaces of the tubular vessel 1 with no contact of the rotating scroll 2 with the internal tubular vessel 1 surface. This also greatly reduces the required rotating torque on the scroll 2 and reduces erosion or abrasive wear on the outer scroll 2 edge and the tubular vessel 1 walls as the scroll 2 never contacts the internal tubular vessel 1 surface.

It is a purpose of the present disclosure to overcome the complexity of operating dual overlapping screw shafts or multiple high speed rotating shafts and paddles to break up the thick pastes. The present disclosure can use two features to efficiently and simply handle melted and/or paste-like and sticky input materials: 1) low speed shaftless scroll and 2) elimination of scroll contact with or scraping action of the internal surfaces of the process vessel. The slowly rotating scroll of the present disclosure breaks up bulk pastes and sticky materials into small lumps or pieces, the scroll cannot be blinded or fouled by thick pastes and sticky materials as there is no shaft or connecting arms around which pastes tend to accumulate or adhere, the scroll imparts slow movement in the heated media bed, the smaller lumps of pastes or sticky input materials thinly coat the media bed that has a very high surface area, the media bed beads are sufficiently hot that the thin paste or sticky coating on each media bead is dried such that bulk agglomerations and bed plugging do not occur and importantly, all surfaces of the shaftless rotating scroll(s) are in contact with and subject to the shear action of the media balls such that all surfaces of the scroll(s) are maintained clear of deposits. Another feature that can prevent problematic handling of paste-like materials is that the rotating scroll and tubular vessel are elongated compared to prior art moving bed devices, such that the center portion of the media bed is relatively close to the rotating scroll(s), which effectively shears any paste-like or sticky materials in the center of the media bed as there is no central shaft, no connecting arms between the shaft and the spiral mixing device, no multiple overlapping screws or high speed device operation, and no contact of the rotating scroll and the inside heated surface of the tubular vessel.

Thereby, the paste-like and sticky input materials can be readily dried and/or reacted without forming clumps or blockages inside the tubular vessel. This is a unique capability of the present disclosure that was determined by evaluating and testing several issues with thermally treating such pastes in prior art screw conveyor dryers as the pastes will stick to the screw conveyor flights and shafts and cannot be removed without shutting down the process.

Further, a number of waste streams exist where it is desired that the waste stream be converted into stable, water-insoluble, mineralized products. Prior art has treated this paste-producing input material that has a melted intermediate phase by using a very high temperature vitrification melter (greater than 1100° C.) or by atomizing the input materials into small droplets in a special type of high-temperature fluidized bed (greater than 700° C.). Significant capital and operating costs are associated with treating such wastes using these complex, high temperature processes. The present disclosure provides the remarkable capability to thermally treat heavy paste-like input materials that also have melted intermediate phases without causing plugging, blockage, loss of temperature control, or formation of hard rock-like agglomerations. Example 3 provides a commercial application for the treatment of thick paste-like input materials, such as the thick clay slurry using the present disclosure. In Example 3 the heavy clay slurry forms small hard, mineralized granules during thermal treatment at temperatures as low as 400° C., which is a feature of the present disclosure and has never been previously performed at such a low temperature nor with a non-fluidized media bed.

Co-reactants can be added into the tubular vessel to facilitate change in chemistry or physical properties or characteristics of the input materials. Co-reactants may be in solid, liquid and/or gaseous form. Examples of typical co-reactants follow. One or more co-reactants may be added into the tubular vessel that would assist in or facilitate or cause destruction or volatization of organic compounds in input materials include the following, but are not limited to; reactive gases, such as steam, oxygen, carbon monoxide, carbon dioxide, halogens; and/or reactive solids and/or liquids, such as: nitrates, nitrites, metal particles, catalysts, oxidizers, reductants, mineralizing or stabilizing additives, etc. It is not the purpose of the present disclosure to specify what co-reactants can be used for individual input materials but rather to note that co-reactants can be input to the tubular vessel in one or more of the following methods: into the top region 10-T, into the middle region 10-M, into the bottom region 10-M or pre-mixed with the input materials 10.

Additionally, co-reactants for thermal treatment of inorganic constituents could include gases, liquids and/or solids and include but are not limited to: catalytic metals, such as Pd or Pt; reductants (for example: for nitrates the potential reductants include: sucrose or formic acid or carbon-containing or organic co-reactants); clays; steam; oxygen; halogens (Cl, F, Br); oxidizers, mineralizing or stabilizing additives (such as clays, calcium silicates, cements, aluminum hydroxide, calcium oxide or hydroxide, magnesium oxide or hydroxide, and so forth).

Further, one or more co-reactants may be added into the tubular vessel that would assist in or facilitate or convert or otherwise cause carbon-containing compounds in the input materials to be gasified into carbon-oxides or carbon-chain organic vapors, volatile organic carbons (VOCs). Such gasification co-reactants include, but are not limited to: reactive gases, such as: steam, oxygen, air, nitric acid vapors (NOx), ozone, carbon dioxide, carbon monoxide, etc. and/or reactive liquids or solids, such as: nitrates, nitrites, ammonia, urea, etc.

At least one feature of the present disclosure is that the physical and/or chemical properties or characteristics of the input materials and/or residual solids can be changed along the length of the tubular vessel. For instance, as discussed in Example 3, when treating a sodium nitrate, sodium nitrite and/or sodium hydroxide-based waste; 1) the waste and a denitration co-reactant (such as sucrose) and other co-reactant(s) can be input into the first zone or region; 2) the heat input into the first zone will evaporate the majority of the water or liquid forming a paste; 3) further heat input into the second zone can fully evaporate the water and other liquids from the thick paste from the first zone forming substantially dry solids; 4) in the third zone the dry solids with partially melted nitrates and nitrites form a thick, heavy paste; 5) in the fourth zone the partially melted paste from the third zone will be further heated to denitrate (destroy the nitrates and nitrites producing nitrogen and minimal NOx gases) to form mainly sodium hydroxide and related intermediates from the sodium nitrates and nitrites in the input materials thereby modifying and forming a thick paste with modified composition; 6) in the fifth heated zone, one or more mineralizing co-reactant(s) (such as clay or aluminum hydroxide) may be added to the denitrated solids from the fourth zone, although the mineralizing co-reactants may be added initially into the first zone for convenience; 7) in the sixth zone, the denitrated sodium compounds (such as hydroxides) that melted in the fourth zone will combine with and react with the added mineralizing co-reactant(s) to produce dry, free-flowing water-insoluble or high melting mineral compound granules (such as alumino-silicates and other mineral forms); 8) in the seventh heated zone organics in the input materials can be thermally decomposed, and 9) in the bottom of the tubular vessel the treated residues with organics removed are then discharged from the output end of the tubular vessel. Such staged thermal treatment in a single vessel is unique to the present disclosure and is feasible due to the use of an elongated tubular vessel, with shaftless scroll and agitated media bed with multiple independently heated zones along the length of the elongated tubular vessel.

Examples of how the present disclosure can be used to treat challenging input materials are provided as follows:

Example 1: Treatment of Liquid Input Materials that Convert to Dried Solid Treated Residues. Many potential input materials are solutions or slurries with a large organic liquid or water content in which case an example configuration is to introduce the input materials and any co-reactants into the top region (10-T) of the tubular vessel. The liquids wet or contact the hot media bed structures resulting in rapid evaporation of the liquid phase. At least one unique advantage of the present disclosure is that the tubular vessel is several times longer than it is in diameter, such that the liquids that are input into the 10-T top region of the tubular vessel are quickly evaporated before the liquid can flow downward out of the upper region of the tubular vessel.

The liquid components of the input materials introduced into the top (upper elevation end) of the tubular vessel are evaporated by heat transfer from the heaters through the tubular vessel walls along the top region of the tubular vessel to the media bed and then to the input materials. The very large surface area of the media bed prevents liquids from flowing quickly downward in the media bed as the liquids will form a thin layer around the hot media bed balls that results in rapid evaporation of water and other low boiling point liquids. In addition, the recycle of the hot media bed moved upward from the hotter lower region of the tubular vessel by the rotating scroll also facilitates complete evaporation of liquids exclusively in the upper region of the tubular vessel.

The resultant dried solids from evaporation of the input materials thinly coat the recirculating media bed beads that then continuously moves downward into the lower region (lower elevation end) of the tubular vessel by the rotating scroll and recirculating media bed motion. During the slow downward passage, the input materials may be mixed with co-reactants along the length of the tubular vessel (10-M location). As dried input materials and co-reactants (if any) are slowly transferred downward along the length of the tubular vessel, the movement between the media bed beads causes the dried solids to flake off the surface of the media bed beads and from the external surfaces of the rotating scroll and the heated internal tubular vessel surfaces. The dried solids then fall by gravity through the media bed and are removed from the lower end of the tubular vessel 20-B. Gases from thermal treatment may be removed from the top of the tubular vessel, 30-T, or from the bottom of the tubular vessel 30-B.

In this example the present disclosure would generally be arranged and operated as shown in FIG. 1, 2 or 5. The heat source for this example is selected to maintain the tubular vessel walls at a temperature that will not result in unwanted physical decomposition or thermal damage to the final dried treated residues or product. Additional heat input can be achieved by installing a centralized heat source along the longitudinal centerline of the tubular vessel, which would involve an installation similar to FIG. 5. The centralized heat source would penetrate through the end of the tubular vessel opposite of the drive-end of the scroll and may extend as far as the drive-end of the scroll to form a long cylindrical heat source with an outer jacket or pipe that is cleaned by the movement of the single-layer thick media bed beads, not by direct contact with the rotating scroll. The heat source may be of any type that properly controls the temperature in each zone or region along the length of the tubular vessel at the desired operating temperature(s). The heat source for production of thermally sensitive dried powder products can be steam or heat transfer fluid as they can maintain uniform temperatures without hot spots that may form using other heat sources.

The thermal treatment in this example is carried out within the temperature range of 80 to 500° C. in the upper region of the tubular vessel, and between 100 and 800° C. in the middle and lower region of the tubular vessel media bed depending upon the temperature sensitivity of the input materials and the treated residues. Additionally, for applications at near ambient pressure when water is to be evaporated from a dilute water-based solution, the upper region of the media bed where water is to be evaporated should be maintained between 120 to 240° C. Water may pass through the upper region of the media bed if the temperature of the upper region of the media bed exceeds 300° C. due to the Liedenfrost effect.

Example 2: Treatment of Liquid Input Materials that Form a Melted Residue. An example of processing a liquid to produce a melted treated residue is now provided. In this example, the input materials consist of a water-based solution of sodium (an alkali metal) nitrates and nitrites that is metered into the top region of the tubular vessel 10-T. The water in the input material solution is quickly evaporated as discussed in Example 1.

The dried sodium nitrate and nitrite salts then move downward in the media bed into lower zones that are maintained at an elevated temperature greater than the melting point of the nitrates and nitrite solids. The dried solids continue to be heated by the media bed until the thin coating of nitrates and nitrites on the media bed beads melts. The melted sodium nitrate and nitrites then flow by gravity through the media bed and are drained from the lower end of the tubular vessel 20-B.

Foam generation is prevented in the upper region of the tubular vessel during the drying and melting operations as the liquid input material coats the hot media bed beads with a thin layer such that water is evaporated without foam generation, e.g., there is not sufficient liquid on the surface of the media bed beads to form a liquid bubble (foam bubble).

The thermal treatment in this example is carried out within the temperature range of 180 to 550° C. in the upper region of the tubular vessel, and between 350 and 600° C. in the middle and lower region of the tubular vessel media bed. In this example, the tubular vessel would be arranged and operated as shown in FIG. 1 or 5.

Example 3: Treatment of Input Materials with Co-Reactants to Form a Mineralized Treated Residue. This example illustrates how input materials can be treated with co-reactants to form a solid-phase, water insoluble, mineralized treated residue. In this example, the input materials consist of a water-based solution of sodium hydroxide, sodium nitrates, sodium nitrites and a wide variety of minor inorganic and organic constituents, such as is typical of waste solutions from nuclear fuel reprocessing facilities produced by the US Department of Energy, often referred to as tank wastes.

The objective of thermal treatment of this alkali-based waste is to convert the cations (sodium, potassium, metals, etc.) into stable, water-insoluble minerals that can be directly disposed of in a geologic repository.

For this application, two co-reactants are utilized: sucrose to convert the nitrates and nitrites into nitrogen gas and clay to convert the alkali metals (mainly: sodium and potassium) into stable, water-insoluble alumino-silicate mineral forms.

The input materials and the two co-reactants are introduced into the top region of the tubular vessel 10-T. The two co-reactants can be mixed with the input materials prior to being input into the tubular vessel. The input materials (tank waste in this example) when mixed with the sucrose and clay produces a heavy, thick slurry that is input into the top region of the tubular vessel. The water content of the input materials is evaporated in the upper region of the tubular vessel by heat transfer as discussed in Example 1 above.

The resultant dried solids consisting of the following major compounds: sodium hydroxide, sodium nitrate, sodium nitrite, sucrose and clay and a wide variety of minor organic and inorganic compounds, move downward through the media bed inside the tubular vessel. As the dried solids heat up to between 150 and 250° C., the sucrose will react with the nitrates and nitrites to convert them into nitrogen gas and a small amount of NOx. During the sucrose denitration the sodium nitrate and nitrite compounds are converted to intermediate sodium and potassium hydroxides, which melt in the media bed. The highly reactive hydroxides readily react with the clay co-reactant particles to form dried, free-flowing, stable, water-insoluble, mineralized sodium alumino-silicate compounds that form the final treated residues from the treatment process.

Organics in the input materials are thermally decomposed as the mineralized solids continue to move downward through the heated media bed. The organics in the input materials form VOC vapors that combine with the steam from the evaporation of the water in the input material to produce the process outlet gas from the tubular vessel.

The treated residues are dry, free-flowing granules or powders that move by gravity through the media bed and are discharged out the bottom of the tubular vessel 20-B. The evolved steam, nitrogen, VOCs, and minor gas constituents, such as NOx, are discharged from the top of the tubular vessel 30-T, but can also be discharged from the bottom of the tubular vessel 30-B.

The present disclosure can safely and continuously produce a dried mineralized product (treated residues) and a gas stream that are discharged and handled by a suitably designed solids handling system and downstream offgas system, respectively. The denitration reactions and mineralization reactions of this embodiment occur at much lower temperatures than in any previous method, e.g. vitrification or fluid bed treatment, as mentioned above. Thermal treatment in this example is carried out with the upper region of the tubular vessel, where water evaporation occurs, maintained between 150 and 550° C., the denitration and mineralization reactions occur in the middle and lower regions of the tubular vessel media bed at temperatures between 250 and 650° C., which is 250 to 600° C. lower than prior art denitration mineralization treatment processes. In this example the tubular vessel is arranged and operated as shown in FIG. 1, 2 or 5.

Example 4: Thermal Treatment of Radioactive Organic Ion Exchange Resin. The nuclear power industry utilizes ion exchange resins to prepare demineralized water for use in the reactor and steam generator systems and for polishing (removing trace inorganic contaminants) recirculating water in the reactor and support systems. The resins thereby become contaminated with radioactive species, such as Cs, Ni, Mn, Fe and other metals that are inherent in the reactor systems, particularly if reactor fuel bundle issues occur.

Thermal treatment of the radioactive ion exchange resins that consists of polystyrene or polyacrylic long-chain polymer structures with accumulated inorganic contaminants has several benefits; 1) provides volume reduction so the final radioactive waste that is processed and packaged for disposal has a much lower volume than the as-generated resins; 2) the removal of the organic resin polymer structure can eliminate disposal issues, such as swelling of the resins that may rupture the disposal container and generation of organic VOCs due to natural processes such as bacteria contact; and 3) the resultant volume-reduced inorganic constituents can be more effectively solidified to prevent leaching of unwanted radioactive species into the groundwater of the disposal site.

For treatment of radioactive ion exchange resins (generally polystyrene or polyacrylic polymer beads) according to the present disclosure, the tubular vessel can be arranged in a sloped configuration, as shown in FIG. 6 or FIG. 7. For treatment of small volumes of ion exchange resins, a batch treatment method is utilized as shown in FIG. 6. For treatment of larger volumes of resins or if continuous treatment operation is preferred, the continuous treatment method is utilized as shown in FIG. 7. This example is based upon treatment of large volumes of resins using the method as shown in FIG. 7. The resin waste is transferred to the treatment system as a water-based slurry. The water-resin slurry is introduced into the dewatering filter unit that is integral with and external to the upper section of the tubular vessel. The outer region of the dewatering filter is maintained under a lower pressure than the resin slurry and the tubular vessel. The water from the slurry passes through the dewatering separation or filter media and is discharged or returned to the facility for further use to slurry additional resins. The resins are thereby partially dewatered but still contain most of the interstitial water that remains between the resin beads. The interstitial water is then removed as an external gas source, generally air or nitrogen, is then introduced into the partially dewatered resin inside the dewatering media. The gas flows through the resin particles pushing the residual interstitial water to and through the dewatering media, thereby fully dewatering (substantially all the slurry and interstitial water is removed) the resins just prior to the resins falling by gravity into the tubular vessel at the 10-M position. Inside the tubular vessel, the internal water inside the resin beads is evaporated upon contact with the hot media bed producing dry organic polymer particles that then thermally decompose to form a carbon-rich, partially volume reduced residue that collects in the tubular vessel media bed. Typical volume reduction of the carbon-rich residue is a factor of 3 to 11 times lower than the dewatered input resins.

The dewatering media/filter is generally constructed of metal alloys suitable for the operating conditions of the tubular vessel, if located inside the tubular vessel (as shown in FIG. 6). The dewatering filter media is sized to prevent the subject resin particles from flowing out of the dewatering media with the separated water.

The optional gas-phase filters (shown in FIG. 6) are generally constructed of metal alloys or ceramics suitable for the operating conditions of the tubular vessel. Typical metals include iron-based alloys with high nickel and chromium content together with minor alloying elements, such as Mo, Co, etc. that are formed into sintered powder or mesh configurations. Typical ceramic materials for the optional gas-phase filters include: ceramic fibers, monolithic ceramics of bonded powder or grains including high alumina, silicon carbide, etc.

Significant additional volume reduction can be achieved by contacting the carbon-rich residues with a gasification agent, such as an oxygen-containing gas that can be injected into the tubular vessel at 10-B and/or 10-M positions. The oxygenated gas or suitable oxygen-containing solids will gasify all or a portion of the carbon in the residues to produce a final, very-low volume treated residue. This is possible as in the inclined position, the tubular vessel and media bed can accommodate the accumulation of significant amounts of residues such that the residues can be successfully batch-treated with gasification agent to produce a final treated residue that has essentially no carbon content. Once the gasification step is complete for removing carbon from the residues, the resultant treated residues can be batch transferred from the tubular vessel at 20-B. Oxygen-containing gases and solids may include: air or oxygen mixed with nitrogen or other inert gas, nitrates, steam, carbon dioxide, etc.

This is another unique feature of the present disclosure as the tubular vessel can accommodate significant accumulation of residues in the media bed without impacting the continued input of resin materials into the tubular vessel as resin treatment continues even during carbon gasification. The ability to hold-up or retain the input materials and/or the treated residues for hours instead of seconds (as is typical in prior art media bed processes) allows for full conversion of the input materials to the desired chemical and physical form while in the media bed. The retention of the input materials and/or the treated residues is achieved in either of the following two ways: 1) the tubular vessel is inclined into a sloped (non-vertical) position such that input materials and treated residues do not fall by gravity out of the media bed but rather are moved to the solids outlet 20-B of the tubular vessel by the rotation of the scroll and movement of the media bed or 2) solids retention in the bed can be achieved by installation of a valve or similar closure device or restriction on the treated residue outlet of the tubular vessel 20-B. In this manner, solids that are held-up in the tubular vessel and media bed can be intermittently removed by increasing the speed of the rotating scroll and/or by opening the solids outlet valve or restriction after the solids have reached the desired residence time in the media bed.

A unique feature of the present disclosure is the arrangement of the tubular vessel in an inclined position with or without a treated residue outlet closure or restriction device such that input materials and/or treated residue residence times in the media bed can be effectively controlled. The capability to operate the tubular vessel in the inclined (non-vertical and non-horizontal) position to control the residence time of input materials and/or treated residues is unique to the present disclosure and is not feasible in any prior art processes that have media beds.

In addition, by select addition of co-reactants the present disclosure can convert most cation and non-volatile anion constituents of the treated residues from ion exchange resin treatment into water insoluble minerals without the need for vitrification or use of high temperatures. Suitable mineralizing co-reactants include the following; aluminum compounds to form aluminates; alkaline earth compounds to adsorb sulfur or halogens contained in or adsorbed on the resins; metals, such as Fe, Mn, Ni, Cr to form spinel compounds; and related inorganic co-reactants.

Thermal treatment of ion exchange resins is carried out with the tubular vessel and media bed at temperature between 350 and 650° C.

Example 5: Thermal Treatment of Biomass and Solid Wastes. For treatment of biomass and solid wastes, such as municipal solid wastes or radioactive dry active wastes (DAW), the tubular vessel can be arranged in a sloped configuration, as shown in FIG. 2, and operated the same as in Example 4, except the drive-end of the scroll will be on the lower elevation end of the tubular vessel. The solid wastes or biomass are input into the middle position 10-M of the tubular vessel. Water in the input materials is evaporated upon contact with the hot media bed, thereby producing dry solids that then thermally decompose to form a carbon-rich, partially volume reduced residue that collects in the tubular vessel media bed. Typical volume reduction of the carbon-rich residue is a factor of 3 to 20 times lower than the input waste materials.

The biomass may be any source of organic materials, such as: straw, weeds, algae, timber wastes, agricultural wastes, sewage, etc. The purposes of the thermal treatment of the biomass are: 1) produce an organic-rich VOC stream from which valuable organic compounds can be extracted to produce bio-fuel, chemical intermediate products, etc. and 2) produce energy from the produced non-essential VOC gases that are not suitable for use in preparing bio-fuel or chemical intermediates. The heat from the produced non-essential VOC gases can be used as the external heat source to maintain the tubular vessel at the desired operating temperature with residual heat in the offgas used to produce steam for additional energy generation.

Solid wastes include typical DAW and trash materials, such as: paper, plastic, rubber, wood, cloth, fibrous or stringy materials, etc. As with biomass, the constituents of the concentrated VOC outlet gas stream can be utilized for preparing bio-fuels or energy generation among other uses or can be simply oxidized in a typical thermal oxidizer.

Significant additional volume reduction of the carbon-rich residues can be achieved beyond what the thermal decomposition of the organics in the biomass or solids wastes produces by contacting the carbon-rich residues with a co-reactant gasification agent, such as an oxygen-containing gas that can be injected into the tubular vessel at 10-B. The oxygenated gas will gasify all or a portion of the fixed carbon in the residues to produce a final, very-low volume final treated residue (ash). In addition, the gasification of fixed carbon and residual organics in the input materials in the media bed will produce energy input into the media bed, which is an effective internal heat source. This is possible as in the inclined position, the tubular vessel, shaftless scroll and media bed can accommodate the accumulation of significant amounts of input materials and/or residues/ash such that the residues can be successfully batch treated with gasification agents to produce a final treated residue/ash that has essentially no carbon content. Once the gasification step is complete for removing carbon from the residues, the resultant treated residues can be batch transferred from the tubular vessel at 20-B (as discussed in Example 4) generally, concurrent with continued input material treatment. Oxygen-containing gases and solids may include: air or oxygen mixed with nitrogen or other inert gas, nitrates, steam, carbon dioxide, etc. The input of oxygen-containing co-reactants into the media bed is also an effective means to produce internal heat generation inside the tubular vessel and will reduce the amount of heat required from external heat sources.

This is another unique feature of the present disclosure as the inclined tubular vessel with shaftless scroll and media bed can accommodate significant accumulation of residues in the media bed without impacting the continued input and thermal treatment of biomass or solid wastes materials into the tubular vessel.

Alternatively, the carbon-rich residues may be removed from a first tubular vessel and the carbon in the residues gasified in a separate second tubular vessel to produce energy that can be used to provide the heat required in the first and second tubular vessels. The separate gasification of the carbon in the residues ensures that the VOC-rich gas outlet stream from the first tubular vessel is not diluted by the gasification gas input, which will enhance the value of the evolved VOC stream for bio-fuel and chemical intermediate production.

For biomass and solid waste, the input materials can be partially size reduced to facilitate efficient, semi-continuous input into the tubular vessel. This facilitates more efficient heat transfer and increases the system throughput. Large inorganic input materials input into the tubular vessel will be moved by the scroll movement to the upper end of the tubular vessel where an airlock assembly may be provided for intermittent removal of large accumulated inorganic items, such as: rocks, etc. To facilitate more efficient treatment of larger organic items, such as pieces of wood, the scroll can be provided with teeth or lugs that facilitate size reduction and improved mixing of the media bed and the larger organic components. The shaftless scroll is particularly suited for treating fibrous or stringy materials that will wrap around and choke a typical shaft-driven screw device as the rotation of the scroll of the present disclosure will move any materials wrapped around the scroll to the non-driven (no-shaft) end where the fibrous or stringy materials will be released from being wrapped around the scroll and are returned back into the media bed.

In addition, select addition of co-reactants to the media bed can efficiently adsorb released acid gases such as chlorine from treatment of PVC plastics, sulfur from treatment of rubber, etc.; thereby the release of acid gases into the process outlet gas is minimized. The co-reactants for in-bed acid gas adsorption can be alkaline earth compounds, such as: calcium or magnesium hydroxide, aluminum compounds, etc.

Thermal treatment of biomass and solid wastes is carried out with the tubular vessel and media bed at temperature between 350 and 800° C. Generally, the entire tubular vessel is maintained at the same temperature as the media bed and accumulated residues, except in the region where oxygen-containing co-reactant(s) are added.

Additional applications, implementations, and/or configurations of the present disclosure will be apparent to knowledgeable process designers. Other applications and embodiments of the present disclosure may require operation of the tubular vessel at temperatures as low as 60° C., for vacuum distillation, or as high as 800° C. for some thermal conversion applications, which is the normal maximum operating temperature of metal vessels.

For the present disclosure, specifications for the support systems for receiving, storing, metering, cooling, oxidizing, scrubbing, filtering, and other unit operations for the input materials, treated residues and gases are not discussed nor claimed due to the wide range of systems that would be required to account for each different application for such a wide diversity of input materials.

1: A waste treatment system comprising:
an elongated vessel having a length greater that a width, the elongated vessel comprising:
an inlet configured to receive waste for treatment;
a solids outlet configured to discharge solid treated waste residue; and
a gas outlet configured to discharge gas generated during waste treatment;
one or more scroll(s) within the vessel and configured to be rotated therein; and
a media bed within the vessel and physically engaged with the scroll.

2: The waste treatment system of claim 1 wherein the elongated vessel is cylindrically shaped with a length to diameter ratio of 3 to 20.

3. (canceled)

4: The waste treatment system of claim 1 wherein the scroll is shaftless within the vessel, except at the drive end.

5. (canceled)

6: The waste treatment system of claim 1 wherein the elongated vessel is oriented in an inclined position.

7-9. (canceled)

10. The waste treatment system of claim 1 further comprising an internal dewatering device within the elongated vessel wherein the wastes can be physically or mechanically dewatered with fluids separated from the waste prior to heating waste.

11. A method for treating waste within an elongated vessel, the method comprising:
providing waste to within an elongated vessel;
exposing the waste to media with a rotating scroll within the elongated vessel to form both a solid treated waste residue and a gas, wherein the scroll is aligned within the vessel using the media;
removing the solid treated waste residue from the elongated vessel via a first discharge conduit; and
removing the gas from the elongated vessel via a second discharge conduit.

12-13. (canceled)

14: The method for treating waste of claim 11 further comprising heating the elongated vessel to at least two different temperatures, a first temperature associated with a first zone of the elongated vessel and a second temperature associated with a second zone of the elongated vessel.

15-18. (canceled)

19: The waste treatment system of claim 1 further comprising a heating assembly provided externally and/or internally to the elongated vessel and media.

20. (canceled)

21: The waste treatment system of claim 1 wherein the scroll is aligned internally inside the elongated vessel, by the media bed, wherein a single layer of media balls serves to align and support the scroll axially inside the elongated vessel.

22: The waste treatment system of claim 1 wherein the wastes are thermally treated to evaporate or concentrate liquids and slurries, and/or melt all or a portion of the input materials, and/or dry the materials to produce solids, and/or decompose or pyrolyze organic materials, and/or to change the waste composition and/or physical properties or characteristics, and/or adsorb gaseous species from the evolved gas stream.

23: The waste treatment system of claim 1 wherein the movement of the media bed and scroll performs one or more of the following functions:
size reduces waste and thermally treated residue solids;
mixes and contacts the waste and any co-reactants internal to the media bed;
provides self-cleaning of all surfaces of the scroll, the internal elongated vessel walls and media;
maintains high heat transfer rates through the elongated vessel walls; and
transfers treated residues produced from thermal treatment of the waste and any co-reactants to the treated residue outlet of the elongated vessel.

24: The waste treatment system of claim 1 wherein one or more co-reactants are added into the elongated vessel with or separately from the waste that assist in or facilitate or cause volatization of waste constituents, oxidation or thermal decomposition of organic compounds in waste, mineralization of waste constituents, and/or cause inorganics in the waste materials to form treated residues that have different form or chemical composition or physical properties or characteristics from the input waste.

25. (canceled)

26: The waste treatment system of claim 1 wherein liquid, slurry, paste or powdered-solid waste and/or co-reactants can be added internally into the media through an input nozzle located concentric with and co-linear (inside) the scroll drive/motor unit that is provided with a hollow drive shaft thereby eliminating splatter or accumulation of waste or residues above the media bed while also eliminating foam generation.

27: The waste treatment system of claim 1 wherein the elongated vessel is provided with a gas-phase filter separation device in the top region of the elongated vessel.

28-31. (canceled)

32: The waste treatment system of claim 1 wherein the media structures are composed of high temperature and fracture resistant metal, metal oxides, or ceramic materials with composition of one or more of the following: ceramics, alumina compounds, silica compounds, zirconia compounds, cerium compounds, magnesium compounds, calcium compounds, glass, and/or inorganic constituents, rocks, zeolytes, porous solids, non-porous solids, metal-containing, metal oxide-containing, minerals, clay, sulfur-adsorbing media, catalytic, and/or halogen-adsorbing media, which media may be inert or reactive or catalytic.
